(19) United States
(12) Patent Application Publication
(10) Pub. No.: US 2024/0330698 A1
(43) Pub. Date: Oct. 3, 2024

(54) LOCAL-SEARCH BASED SOLUTION OF COMBINATORIAL OPTIMIZATION PROBLEM USING ANNEALER-BASED SOLVERS

(71) Applicant: Fujitsu Limited, Kawasaki-shi (JP)

(72) Inventors: Hayato USHIJIMA-MWESIGWA, Dublin, CA (US); Anousheh GHOLAMI, San Diego, CA (US); Indradeep GHOSH, Cupertino, CA (US)

(73) Assignee: Fujitsu Limited, Kawasaki-shi (JP)

(21) Appl. No.: 18/194,431

(22) Filed: Mar. 31, 2023

(51) Int. Cl. G06N 3/092; G06N 3/0442; G06N 3/0455

(52) U.S. Cl. CPC G06N 3/092; G06N 3/0442; G06N 3/0455

(57) ABSTRACT

In an embodiment, a first graph corresponding to an initial solution of a combinatorial optimization problem is received. A reinforcement learning (RL) model is applied on the received first graph. A predefined number of a set of edges is selected from the received first graph. The selected set of edges is deleted from the received first graph to generate a second graph, based on a disconnection of a set of segments associated with the selected set of edges. The generated second graph corresponds to a partial solution. Thereafter, a partial tour may be determined using an annealer-based solver to generate a third graph, based on a connection of the predefined number of a set of disjoint segments. The generated third graph corresponds to a new solution. The RL model is re-trained to determine an improved solution. The determined improved solution is rendered on a display device.

### FIELD

The embodiments discussed in the present disclosure are related to local-search based solution of combinatorial optimization problem using annealer-based solvers.

### BACKGROUND

Advancements in the field of operational research have led to optimization of various processes, such as, production lines, raw material transportation, product distribution, supply-chain related processes, selling of products, and the like. With the growing complexity of the processes, the optimization of such processes has become a non-trivial task. For example, each process may be associated with several constraints, which may have to be satisfied together during the optimization of the process. An example of an optimization problem may be a travelling salesman problem (TSP). The goal of the TSP is to determine optimal routes for a salesman so that the salesman may visit each city exactly once and may return a starting city at the end of a tour. Traditional methods for optimization of the processes may require significant time and computing resources. The TSP may be a challenging optimization problem with many important applications in the transportation industry. Thus, there is a need for efficient techniques to solve optimization problems, such as, the TSP.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include a set of operations, which may include receiving a first graph corresponding to an initial solution of a combinatorial optimization problem. The set of operations may further include applying a reinforcement learning (RL) model on the received first graph. The set of operations may further include selecting a predefined number of a set of edges from the received first graph based on the application of the RL model. The set of operations may further include deleting the selected set of edges from the received first graph to generate a second graph, based on a disconnection of a set of segments associated with the selected set of edges from the received first graph, wherein the generated second graph may correspond to a partial solution of the combinatorial optimization problem. The set of operations may further include determining, using an annealer-based solver, a partial tour of the generated second graph to generate a third graph, based on a connection of the predefined number of a set of disjoint segments in the generated second graph, wherein the generated third graph may correspond to a new solution of the combinatorial optimization problem. The set of operations may further include re-training the RL model based on the generated third graph, wherein the re-trained RL model may be configured to determine an improved solution of the combinatorial optimization problem. The set of operations may further include rendering the determined improved solution of the combinatorial optimization problem on a display device.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to a local-search based solution of combinatorial optimization problem using annealer-based solvers;

FIG. 2 is a block diagram that illustrates an exemplary electronic device for the local-search based solution of the combinatorial optimization problem using the annealer-based solvers;

FIG. 3 is a diagram that illustrates an exemplary scenario for a first graph;

FIG. 4 is a diagram that illustrates an execution pipeline for the local-search based solution of the combinatorial optimization problem using the annealer-based solvers;

FIG. 5 is a diagram that illustrates an exemplary scenario for a RL model, in accordance with at least one embodiment described in the present disclosure;

FIG. 6 is a diagram that illustrates an exemplary scenario for a policy gradient neural (PGN) model associated with an actor-critic architecture;

FIG. 7 is a diagram that illustrates an exemplary scenario for a set of disjoint segments;

FIG. 8 is a diagram that illustrates an exemplary scenario for reconnecting the set of disjoint segments; and

FIG. 9 is a diagram that illustrates a flowchart of an example method for the local-search based solution of the combinatorial optimization problem using the annealer-based solvers;

all according to at least one embodiment described in the present disclosure.

### DESCRIPTION OF EMBODIMENTS

Some embodiments described in the present disclosure relate to methods and systems for local-search based solution of combinatorial optimization problem using annealer-based solvers. In the present disclosure, a first graph corresponding to an initial solution of a combinatorial optimization problem may be received. A reinforcement learning (RL) model may be applied on the received first graph. Based on the application of the RL model a predefined number of a set of edges may be selected from the received first graph. Thereafter, the selected set of edges may be deleted from the received first graph to generate a second graph, based on a disconnection of a set of segments associated with the selected set of edges from the received first graph. The generated second graph may correspond to a partial solution of the combinatorial optimization problem. Further, partial tour of the generated second graph may be determined using an annealer-based solver to generate a third graph, based on a connection of the predefined number of a set of disjoint segments in the generated second graph. The generated third graph may correspond to a new solution of the combinatorial optimization problem. Based on the generated third graph the RL model may be re-trained. The re-trained RL model may be configured to determine an improved solution of the combinatorial optimization problem. The determined improved solution of the combinatorial optimization problem may be rendered on a display device.

According to one or more embodiments of the present disclosure, the technological field of operational research may be improved by configuring a computing system in a manner that the computing system may be able to determine local-search based solution of combinatorial optimization problem using annealer-based solvers. The computing system may receive a first graph corresponding to an initial solution of a combinatorial optimization problem. The computing system may apply a reinforcement learning (RL) model on the received first graph. Based on the application of the RL model, the computing system may selecta predefined number of a set of edges from the received first graph. Further, the computing system may delete the selected set of edges from the received first graph to generate a second graph, based on a disconnection of a set of segments associated with the selected set of edges from the received first graph. The generated second graph may correspond to a partial solution of the combinatorial optimization problem. The computing system may determine, using an annealer-based solver, a partial tour of the generated second graph to generate a third graph, based on a connection of the predefined number of a set of disjoint segments in the generated second graph. The generated third graph may correspond to a new solution of the combinatorial optimization problem. The computing system may re-train the RL model based on the generated third graph. The re-trained RL model may be configured to determine an improved solution of the combinatorial optimization problem. Further, the computing system may render the determined improved solution of the combinatorial optimization problem on a display device.

It may be appreciated that optimization of processes, such as, production lines, raw material transportation, product distribution, supply-chain related processes, selling of products, and the like may be non-trivial tasks. An example of an optimization problem may be a travelling salesman problem (TSP). A goal of the TSP may be to determine optimal routes for a salesman so that the salesman may visit each city exactly once and may return to a starting city at the end of a tour. Traditional methods for optimization of the processes may require significant time and computing resources. The TSP may be a challenging optimization problem with many important applications in the transportation industry.

For example, the TSP may have applications in the transportation industry to design efficient routes for vehicles. The TSP may be an NP-hard problem. Thus, various approximation algorithms and heuristics may be employed to solve the TSP. For example, heuristics may be used to search a neighborhood of the TSP solution space at each iteration. Special-purpose hardware such as quantum computers or quantum-inspired solvers may identify a best solution in a given neighborhood. However, a process of identification of the neighborhood of the TSP solution space, that may be searched, may be non-trivial in itself.

The present disclosure may provide a method to identify the neighborhoods of a combinatorial optimization problem that can be solved by quantum computers and quantum-inspired solvers. In order to do so, an electronic device (such as, the computing system) of the present disclosure may apply the reinforcement learning (RL) model on the received first graph corresponding to the initial solution of the combinatorial optimization problem. Further, the electronic device may select the predefined number of the set of edges and delete the selected set of edges from the received first graph to generate the second graph. The annealer-based solver may be then used to determine the partial tour of the generated second graph and generate the third graph. Herein, the third graph may be generated by connecting the predefined number of the set of disjoint segments in the generated second graph. Thereafter, the RL model may be re-trained in order to determine the improved solution of the combinatorial optimization problem.

Embodiments of the present disclosure are explained with reference to the accompanying drawings.

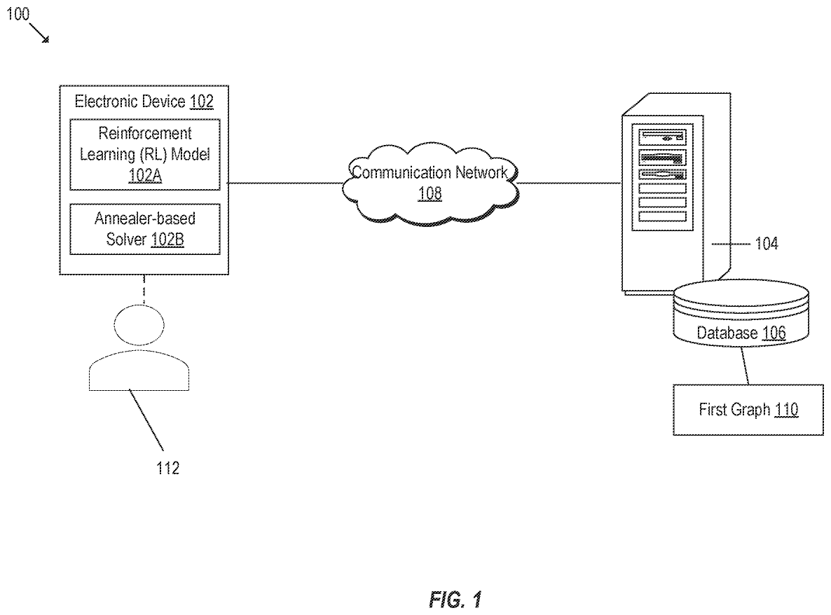

FIG. 1 is a diagram representing an example environment related to a local-search based solution of combinatorial optimization problem using annealer-based solvers, according to at least one embodiment described in the present disclosure. With reference to FIG. 1, there is shown an environment 100. The environment 100 may include an electronic device 102, a server 104, a database 106, a communication network 108, and a first graph 110. The electronic device 102, the server 104, and a device hosting the database 106 may be communicatively coupled to one another, via the communication network 108. The electronic device 102 may include a reinforcement learning (RL) model 102A and an annealer-based solver 102B. In FIG. 1, there is further shown a user 112, who may be associated with or operate the electronic device 102.

The electronic device 102 may include suitable logic, circuitry, and interfaces that may be configured to determine a local-search based solution of a combinatorial optimization problem using annealer-based solvers, for example, the annealer-based solver 102B. The electronic device 102 may be further configured to receive the first graph 110 corresponding to an initial solution of the combinatorial optimization problem. The electronic device 102 may be further configured to apply the RL model 102A on the received first graph 110. The electronic device 102 may be further configured to select a predefined number of a set of edges from the received first graph 110 based on the application of the RL model 112A. Examples of the electronic device 102 may include, but are not limited to, a computing device, a hardware-based annealer device, a digital-annealer device, a quantum-based or quantum-inspired annealer device, a smartphone, a cellular phone, a mobile phone, a gaming device, a mainframe machine, a server, a computer workstation, and/or a consumer electronic (CE) device.

The RL model 102A may be a model that may learn using a feedback-based machine learning method. The RL model 102A may include an agent that may perform an action. The agent may learn a policy based on an outcome of the performed action. A reward-based system may be employed to train the RL model 102A, where a desired behavior may be rewarded, and an undesirable behavior may be penalized. In an embodiment, the RL model 102A may be a neural network.

The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different same mathematical function.

In training of the neural network, one or more parameters of each node of the neural network may be updated based on whether an output of the final layer for a given input (from the training dataset) matches a correct result based on a loss function for the neural network. The above process may be repeated for same or a different input till a minima of loss function may be achieved, and a training error may be minimized. Several methods for training are known in art, for example, gradient descent, stochastic gradient descent, batch gradient descent, gradient boost, meta-heuristics, and the like.

The neural network may include electronic data, which may be implemented as, for example, a software component of an application executable on the electronic device 102. The neural network may rely on libraries, external scripts, or other logic/instructions for execution by a processing device, such as a processor. The neural network may include code and routines configured to enable a computing device, such as a processor to perform one or more operations. Additionally or alternatively, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

In an embodiment, the RL model 102A may include a graph convolutional network (GCN) model, which may be a variant of convolution neural network model that may be used for tasks related to graph-structured data. The GCN model may be trained based on a semi-supervised based learning technique on the graph-structured data. Herein, the GCN model may perform convolutional operations on neighboring nodes associated with the graph-structured data. The GCN model may determine a topological structure associated with an input graph of the GCN model. In an embodiment, the GCN model may be a neural network similar to the neural network of the RL model 102A. The functions of the neural network of the GCN model may be same as the functions of the neural network of the RL model 102A as described. Therefore, the description of the neural network of the GCN model is omitted from the disclosure for the sake of brevity.

In an embodiment, the RL model 102A may include a recurrent neural network (RNN), which may be a neural network model that may operate on sequential data, such as, time-series data. In the RNN model, a past output of the RNN model may be fed back along with a current input. Thus, the RNN model may store information associated with previous input such as, previous input graphs. In an embodiment, the RNN model may correspond to a Long Short-Term Memory (LSTM) model configured to determine a node ordering associated with an input graph. In an embodiment, the RNN may be a neural network similar to the neural network of the RL model 102A. The functions of the neural network of the RNN may be same as the functions of the neural network of the RL model 102A as described previously. Therefore, the description of the neural network of the RNN is omitted from the disclosure for the sake of brevity.

The annealer-based solver 102B may be special purpose hardware, for example, quantum or quantum-inspired hardware that may be useful to solve optimization problems. In one or more embodiments of the disclosure, the annealer-based solver 102B may be implemented as a generalized quantum computing device. In such an implementation, the generalized quantum computing device may use specialized optimization solving software applications (e.g., a Quadratic Unconstrained Binary Optimization (QUBO) or using a solver) at an application layer to implement searching algorithms or meta-heuristic algorithms, such as simulated annealing or quantum annealing, to search for a solution to the optimization problem (such as, the VRP) from a discrete solution space.

The generalized quantum computing device may be different from a digital bit-based computing device, such as digital devices that are based on transistor-based digital circuits. The generalized quantum computing device may include one or more quantum gates that use quantum bits (hereinafter referred to as “qubits”) to perform computations for different information processing applications, such as quantum annealing computations for solving combinatorial optimization problems. In general, a qubit can represent “0”, “1”, or a superposition of both “0” and “1”. In most cases, the generalized quantum computing device may need a carefully controlled cryogenic environment to function properly. The generalized quantum computing device uses certain properties found in quantum mechanical systems, such as quantum fluctuations, quantum superposition of its Eigen-states, quantum tunneling, and quantum entanglement. These properties may help the generalized quantum computing device to perform computations for solving certain mathematical problems (e.g., QUBO functions) which are computationally intractable by conventional computing devices. Examples of the generalized quantum computing device may include, but are not limited to, a silicon-based nuclear spin quantum computer, a trapped ion quantum computer, a cavity quantum-electrodynamics (QED) computer, a quantum computer based on nuclear spins, a quantum computer based on electron spins in quantum dots, a superconducting quantum computer that uses superconducting loops and Josephson junctions, and nuclear magnetic resonance quantum computer.

In some other embodiments, the annealer-based solver 102B may be a quantum annealing computer that may be specifically designed and hardware/software optimized to implement searching algorithms or meta-heuristic algorithms, such as simulated annealing or quantum annealing. Similar to the generalized quantum computing device, the quantum annealing computer may also use qubits and may require a carefully controlled cryogenic environment to function properly.

In some other embodiments, the annealer-based solver 102B may correspond to a digital quantum-computing processor for solving user-end combinatorial optimization problems, which may be submitted in the form of a QUBO formulation. More specifically, the annealer-based solver 102B may be a digital annealer that may be based on a semiconductor-based architecture. The digital annealer may be designed to model the functionality of the quantum annealing computer on a digital circuitry. The digital annealer may operate at room temperature and may not require cryogenic environment to function. Also, the digital annealer may have a specific form factor that may allow it to fit on a circuit board that may be small enough to slide into the rack of a computing device or a computing infrastructure, such as a data center.

In some other embodiments, the annealer-based solver 102B may include a processor to execute software instructions associated with one or more searching algorithms and/or meta-heuristic algorithms, such as simulated annealing or quantum annealing. Examples of the implementation of the processor may include, but are not limited to, a Reduced Instruction Set Computing (RISC) processor, an Application-Specific Integrated Circuit (ASIC) processor, a Complex Instruction Set Computing (CISC) processor, a Graphical Processing Unit (GPU), a Co-processor, and/or a combination thereof.

The server 104 may include suitable logic, circuitry, and interfaces, and/or code that may be configured to delete the selected set of edges from the received first graph 110 to generate a second graph, based on a disconnection of a set of segments associated with the selected set of edges from the received first graph 110. Herein, the generated second graph may correspond to a partial solution of the combinatorial optimization problem. The server 104 may be further configured to determine, using the annealer-based solver 102B, a partial tour of the generated second graph to generate a third graph, based on a connection of the predefined number of a set of disjoint segments in the generated second graph. Herein, the generated third graph may correspond to a new solution of the combinatorial optimization problem. The server 104 may be further configured to re-train the RL model 102A based on the generated third graph. The re-trained RL model may be configured to determine an improved solution of the combinatorial optimization problem. The server 104 may be further configured to render the determined improved solution of the combinatorial optimization problem on a display device. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that may be well known to those ordinarily skilled in the art. A person with ordinary skill in the art will understand that the scope of the disclosure may not be limited to the implementation of the server 104 and the electronic device 102 as two separate entities. In certain embodiments, the functionalities of the server 104 can be incorporated in its entirety or at least partially in the electronic device 102, without a departure from the scope of the disclosure.

The database 106 may include suitable logic, interfaces, and/or code that may be configured to store a plurality of graphs such as, the first graph 110. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device storing the database 106 may be configured to receive a query for the first graph 110 from the electronic device 102. In response, the device of the database 106 may be configured to retrieve and provide the queried first graph 110 to the electronic device 102 based on the received query. In some embodiments, the database 106 may be hosted on a plurality of servers stored at same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the electronic device 102, the server 104, and the device hosting the database 106. The communication network 108 may be one of a wired connection or a wireless connection. Examples of the communication network 108 may include, but are not limited to, the Internet, a cloud network, Cellular or Wireless Mobile Network (such as, Long-Term Evolution and 5G New Radio), a Wireless Fidelity (Wi-Fi) network, a satellite network (e.g., a network of a set of low earth orbit satellites), a Personal Area Network (PAN), a Local Area Network (LAN), or a Metropolitan Area Network (MAN). Various devices in the environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

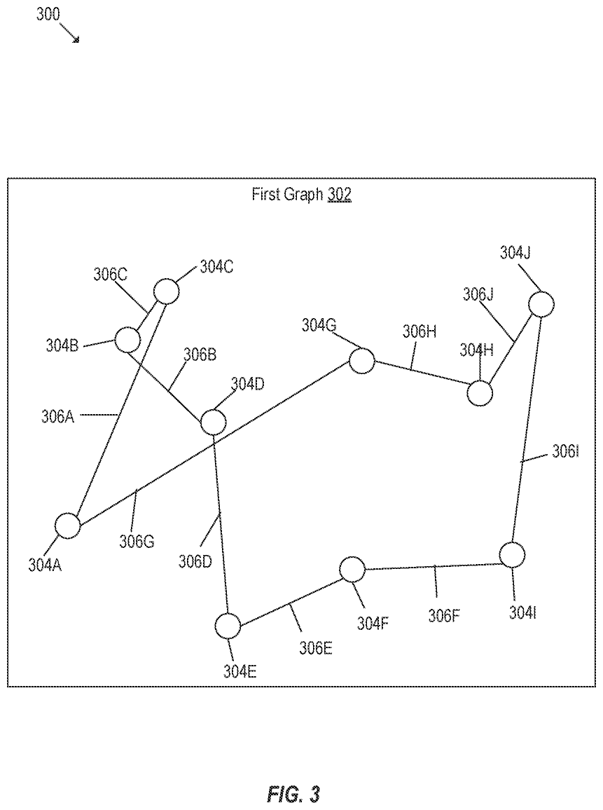

In operation, the electronic device 102 may receive the first graph 110 corresponding to an initial solution of a combinatorial optimization problem. The combinatorial optimization problem may corresponds to at least one of an assignment problem, a closure problem, a constraint satisfaction problem, a cutting stock problem, a dominating set problem, an integer programming problem, a knapsack problem, a minimum relevant variables in linear system problem, a minimum spanning tree problem, a nurse scheduling problem, a set cover problem, a job shop scheduling problem, a traveling salesman problem (TSP), a vehicle rescheduling problem, a vehicle routing problem, a weapon target assignment problem, a bin packing problem, or a talent scheduling problem. For example, in case the combinatorial optimization problem corresponds to a TSP, the first graph 110 may be a closed route such that each node may be visited exactly once. Details related to the first graph are further provided for example, in FIG. 3.

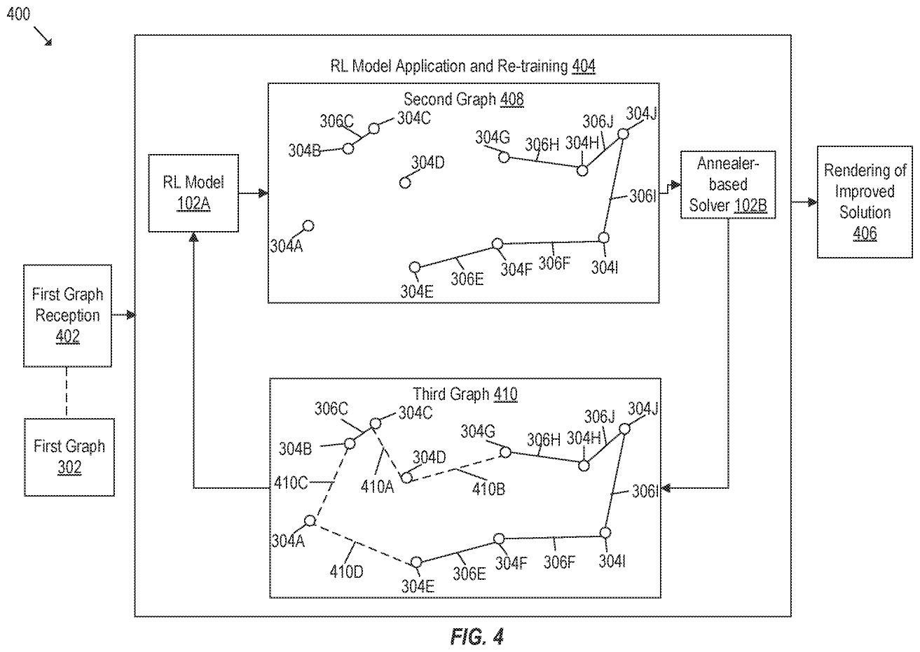

The electronic device 102 may apply the RL model 102A on the received first graph 110. It may be appreciated that the RL model 102A may be a model that may learn policies using a feedback-based learning method. Details related to the RL model are further provided, for example, in FIG. 4.

Based on the application of the RL model 102A, the electronic device 102 may select a predefined number of a set of edges from the received first graph 110. Herein, the predefined number of the set of edges may be a total number of a plurality of edges that may be swapped with new edges. In an example, a “2-opt” heuristic algorithm may be used to select the predefined number of the set of edges. That is, herein, a couple of edges of the received first graph 110 may be selected as the predefined number of the set of edges. Details related to the predefined number of the set of edges are further provided, for example, in FIG. 4.

Once the predefined number of the set of edges are selected, the electronic device 102 may delete the selected set of edges from the received first graph 110 to generate a second graph. The second graph may be generated based on a disconnection of the set of segments associated with the selected set of edges from the received first graph 110. The generated second graph may correspond to a partial solution of the combinatorial optimization problem. For example, in case the 2-opt″ heuristic algorithm is used to select the predefined number of the set of edges, then a couple of edges may be deleted from the received first graph 110 to generate the second graph. Details related to the second graph are further provided, for example, in FIG. 4.

Once the second graph is generated, the electronic device 102 may determine, using the annealer-based solver 102B, a partial tour of the generated second graph to generate a third graph. The third graph may be generated based on a connection of the predefined number of the set of disjoint segments in the generated second graph. The generated third graph may correspond to the new solution of the combinatorial optimization problem. In order to generate the generate the third graph, the set of disjoint segments may be connected. For example, in case the 2-opt″ heuristic algorithm is used, then the couple of edges may be deleted from the received first graph 110 to generate the second graph. Thus, the generated second graph may include a couple of disjoint segments. The couple of disjoint segments may be reconnected to generate the third graph. Details related to the third graph are further provided, for example, in FIG. 4.

Upon generation of the third graph, the electronic device 102 may be configured to re-train the RL model 102A based on the generated third graph. Further, the re-trained RL model 102A may be configured to determine an improved solution of the combinatorial optimization problem. The RL model 102A may be re-trained so that the RL model 102A may learn from its own behavior. The re-trained RL model 102A may thus determine an improved solution that may be an optimal solution of the combinatorial optimization problem. Details related to the re-training of the RL model 102A are further provided, for example, in FIG. 4.

The electronic device 102 may render the determined improved solution of the combinatorial optimization problem on a display device. The rendering of the determined improved solution may allow a salesperson such as, the user 112, to follow a path in accordance with the determined improved solution. The improved solution may be an optimal solution for the combinatorial optimization problem (e.g., the TSP), which may be obtained using lesser time and computing resources, as compared to traditional methods for solving such optimization problems.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the electronic device 102 but not the database 106. In addition, in some embodiments, the functionality of each of the database 106 and the server 104 may be incorporated into the electronic device 102, without a deviation from the scope of the disclosure.

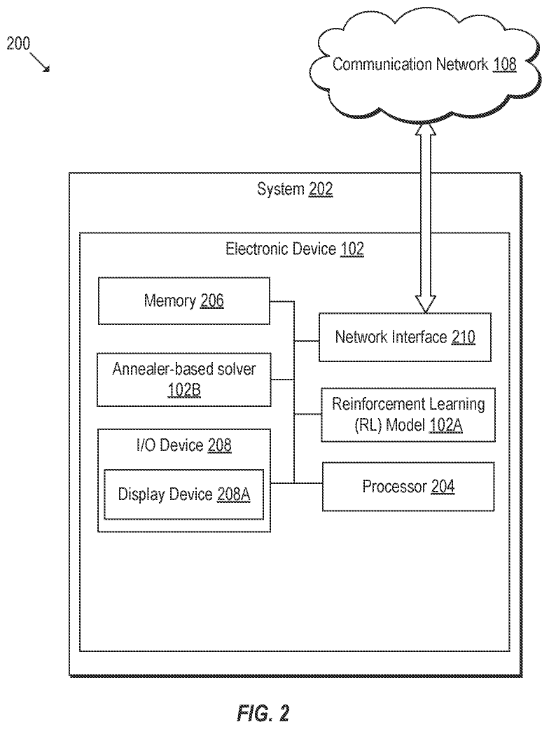

FIG. 2 is a block diagram that illustrates an exemplary electronic device for the local-search based solution of the combinatorial optimization problem using the annealer-based solvers, in accordance with at least one embodiment described in the present disclosure. FIG. 2 is explained in conjunction with elements from FIG. 1. With reference to FIG. 2, there is shown a block diagram 200 of a system 202 including the electronic device 102. The electronic device 102 may include the RL model 102A, the annealer-based solver 102B, a processor 204, a memory 206, an input/output (I/O) device 208 (including, a display device 208A), and a network interface 210.

The processor 204 may include suitable logic, circuitry, and interfaces that may be configured to execute a set of instructions stored in the memory 206. The processor 204 may be configured to execute program instructions associated with different operations to be executed by the electronic device 102. For example, some of the operations may include reception of the first graph 110 corresponding to the initial solution of the combinatorial optimization problem. The processor 204 may be configured to apply the RL model 102A on the received first graph 110. The processor 204 may be configured to select the predefined number of the set of edges from the received first graph 110, based on the application of the RL model 102A. The processor 204 may be configured to delete the selected set of edges from the received first graph 110 to generate the second graph, based on the disconnection of the set of segments associated with the selected set of edges from the received first graph 110, wherein the generated second graph may correspond to the partial solution of the combinatorial optimization problem. The processor 204 may be configured to determine, using the annealer-based solver 102B, the partial tour of the generated second graph to generate the third graph, based on the connection of the predefined number of the set of disjoint segments in the generated second graph, wherein the generated third graph may correspond to the new solution of the combinatorial optimization problem. The processor 204 may be configured to re-train the RL model 102A based on the generated third graph, wherein the re-trained RL model 102A may be configured to determine the improved solution of the combinatorial optimization problem. The processor 204 may be configured to render the determined improved solution of the combinatorial optimization problem on the display device 208A. The processor 204 may be implemented based on a number of processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

Although illustrated as a single processor in FIG. 2, the processor 204 may include any number of processors configured to, individually or collectively, perform or direct performance of any number of operations of the electronic device 102, as described in the present disclosure. Additionally, one or more of the processors may be present on one or more different electronic devices, such as different servers. In some embodiments, the processor 204 may be configured to interpret and/or execute program instructions and/or process data stored in the memory 206. After the program instructions are loaded into the memory 206, the processor 204 may execute the program instructions.

The memory 206 may include suitable logic, circuitry, and interfaces that may be configured to store the one or more instructions to be executed by the processor 204. The one or more instructions stored in the memory 206 may be executed by the processor 204 to perform the different operations of the processor 204 (and the electronic device 102). The memory 206 that may be configured to store the plurality of graphs, such as, the first graph 110, the generated second graph, and the generated third graph. Further, the memory 206 may be configured to store intermediate or partial solutions and improved solutions of the combinatorial optimization problem. Examples of implementation of the memory 206 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 208 may include suitable logic, circuitry, and interfaces that may be configured to receive an input from the user 112 and provide an output based on the received input. For example, the I/O device 208 may receive a request for the first graph 110 as a user input from the user 112. Further, the I/O device 208 may render the determined improved solution of the combinatorial optimization problem on the display device 208A. The I/O device 208 which may include various input and output devices, may be configured to communicate with the processor 204. Examples of the I/O device 208 may include, but are not limited to, a touch screen, a keyboard, a mouse, a joystick, a microphone, a display device (e.g., the display device 208A), and a speaker.

The display device 208A may include suitable logic, circuitry, and interfaces that may be configured to display the determined improved solution of the combinatorial optimization problem. The display device 208A may be a touch screen which may enable a user to provide a user-input via the display device 208A. The touch screen may be at least one of a resistive touch screen, a capacitive touch screen, or a thermal touch screen. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of a head mounted device (HMD), a smart-glass device, a see-through display, a projection-based display, an electro-chromic display, or a transparent display.

The network interface 210 may include suitable logic, circuitry, and interfaces that may be configured to facilitate communication between the processor 204, the server 104, and a device hosting the database 106 (and/or any other device in the environment 100), via the communication network 108. The network interface 210 may be implemented by use of various known technologies to support wired or wireless communication of the electronic device 102 with the communication network 108. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 210 may be configured to communicate via wireless communication with networks, such as the Internet, an Intranet, or a wireless network, such as a cellular telephone network, a wireless local area network (LAN), a satellite network, and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

Modifications, additions, or omissions may be made to the example electronic device 102 without departing from the scope of the present disclosure. For example, in some embodiments, the example electronic device 102 may include any number of other components that may not be explicitly illustrated or described for the sake of brevity.

FIG. 3 is a diagram that illustrates an exemplary scenario for a first graph, in accordance with at least one embodiment described in the present disclosure. FIG. 3 is described in conjunction with elements from FIG. 1 and FIG. 2. With reference to FIG. 3, there is shown an exemplary scenario 300. The exemplary scenario 300 may include a first graph 302. The first graph 302 may include a set of nodes and a plurality of edges. The set of nodes may include a node 304A, a node 304B, a node 304C, a node 304D, a node 304E, a node 304F, a node 304G, a node 304H, a node 304I, and a node 304J. The plurality of edges may include an edge 306A, an edge 306B, an edge 306C, an edge 306D, an edge 306E, an edge 306F, an edge 306G, an edge 306H, an edge 306I, and an edge 306J.

With reference to FIG. 3, the first graph 302 may correspond to the initial solution of the combinatorial optimization problem such as, a traveling salesman problem. Each node of the first graph 302 may be associated with a geographical location. For example, the node 304A may be associated with a geographical location “A”, the node 304B may be associated with a geographical location “B”, the node 304C may be associated with a geographical location “C”, and so on. Each edge may be a connection between a pair of nodes. For example, the edge 306A may connect the node 304A and the node 304C, the edge 306B may connect the node 304B and the node 304D, the edge 306C may connect the node 304B and the node 304C, and so on. In an embodiment, each edge may be associated with a weight that may correspond to a distance of a path between the pair of nodes that the corresponding edge connects. In an example, the first graph 302 may be associated the traveling salesman problem. Herein, a salesman may traverse along the edges to cover each geographical location. The salesman may start a trip from the geographical location associated with the node 304A and may return to the geographical location associated with the node 304A after covering the geographical locations associated with the nodes 304B to 304J exactly once in the trip. In an example, a sequence in which the salesman may visit the geographical locations associated with the set of nodes may be 304A, 304C, 304B, 304D, 304E, 304F, 304I, 304J, 304H, 304G, and 304A along the edges 306A, 306C, 306B, 306D, 306E, 306F, 306I, 306J, 306H, and 306G respectively.

It should be noted that the scenario 300 of FIG. 3 is for exemplary purposes and should not be construed to limit the scope of the disclosure.

FIG. 4 is a diagram that illustrates an execution pipeline for the local-search based solution of the combinatorial optimization problem using the annealer-based solvers, in accordance with an embodiment of the disclosure. FIG. 4 is described in conjunction with elements from FIG. 1, FIG. 2, and FIG. 3. With reference to FIG. 4, there is shown an execution pipeline 400. The exemplary execution pipeline 400 may include a set of operations that may be executed by one or more components of FIG. 1, such as, the electronic device 102. The operations may include a first graph reception operation 402, an RL model application and re-training operation 404, and an improved solution rendering operation 406. The set of operations may be performed by the electronic device 102 for local-search based solution of combinatorial optimization problem using annealer-based solvers, for example, the annealer-based solver 102B of FIG. 1, as described herein.

The execution pipeline 400 may further include a second graph 408 and a third graph 410. The second graph 408 may include a set of nodes and a plurality of edges. The set of nodes of the second graph 408 may include the node 304A, the node 304B, the node 304C, the node 304D, the node 304E, the node 304F, the node 304G, the node 304H, the node 304I, and the node 304J. The plurality of edges of the second graph 408 may include the edge 306C, the edge 306E, the edge 306F, the edge 306H, the edge 306I, and the edge 306J. The third graph 410 may include a set of nodes, such as, the node 304A, the node 304B, the node 304C, the node 304D, the node 304E, the node 304F, the node 304G, the node 304H, the node 304I, and the node 304J. Further, the third graph 410 may include a plurality of edges, such as, an edge 410A, an edge 410B, an edge 410C, an edge 410D, the edge 306C, the edge 306E, the edge 306F, the edge 306H, the edge 306I, and the edge 306J.

At 402, an operation of a first graph reception may be executed. In an embodiment, the processor 204 may be configured to receive the first graph 302 corresponding to the initial solution of the combinatorial optimization problem. The first graph 302 may correspond to a route such that each node of the first graph 302 may be visited or traversed exactly once prior to a traversal back to a starting node at the end of the route. In an example, the processor 204 may receive a set of nodes of the first graph 302 and an order of traversal of the set of nodes of the first graph 302 as an initial solution of the combinatorial problem, such as, the TSP. Thus, the initial solution may be represented in the form of the first graph 302. Details related to the first graph are further provided for example, in FIG. 3.

In an embodiment, the combinatorial optimization problem may correspond to at least one of, but not limited to, an assignment problem, a closure problem, a constraint satisfaction problem, a cutting stock problem, a dominating set problem, an integer programming problem, a knapsack problem, a minimum relevant variables in linear system problem, a minimum spanning tree problem, a nurse scheduling problem, a set cover problem, a job shop scheduling problem, a traveling salesman problem, a vehicle rescheduling problem, a vehicle routing problem, a weapon target assignment problem, a bin packing problem, or a talent scheduling problem.

The assignment problem may be a transportation problem. An objective of the assignment problem may be to assign a number of tasks to an equal number of agents such that a total cost of the assignment may be minimum. The closure problem may be a problem of determining a maximum-weight or a minimum-weight closure of a weighted directed graph. Herein, the closure may be the weighted directed graph such that no edge may leave beyond a set of nodes associated with the weighted directed graph. The constraint satisfaction problem may be a problem of a set of entities such that state of each entity may satisfy a set of constraints associated with the set of entities. The cutting stock problem may be a problem of splitting a material into pieces of specified sizes such that a waste generated due to splitting of the material into pieces may be minimized. The integer programming problem may be an optimization problem where at least one variable associated with the integer programming problem may be constricted to be an integer. The knapsack problem may be a problem of determining a collection of products such that a total weight of the collection of products may be within a limit and a total value of the collection of products may be maximum. The minimum relevant variables in linear system problem may determine a solution such that a number of variables associated with the linear system problem that may take non-zero values may be minimum. The minimum spanning tree problem may determine a tree such that weights of edges associated with the tree may be minimum. The nurse scheduling problem may assign shifts and rooms of a health center to a plurality of nurses, such that, constraints associated with the nurse scheduling problem may be satisfied. The set cover problem may determine a minimum collection of sets from a plurality of sets such that a union of the collection of sets may correspond to a universal set. Herein, the union of the plurality of sets may be the universal set. The job shop scheduling problem may be a problem of assigning a plurality of jobs of varying processing times to a plurality of machines with varying processing power. The traveling salesman problem may find a shortest tour through a set of cities such that each city may be visited exactly once, and the salesperson may return to a starting city. The vehicle routing problem (VRP) problem may be a problem of assignment of a set of routes to a set of vehicles such that a total cost associated with running the set of vehicles on the set of routes may be minimized. The weapon target assignment problem may assign a set of weapons to a set of targets such that destruction caused by an opponent may be minimized. The bin packing problem may pack a set of items of varying sizes to a set of bins of varying such sizes such that a number of bins used to pack the set of items may be minimum. The talent scheduling problem may determine schedules for a set of scenes associated with a film such that, a total cost of salary to be paid to actors. Based on the combinatorial optimization problem, the first graph 302 corresponding to the initial solution of the combinatorial optimization problem may be received.

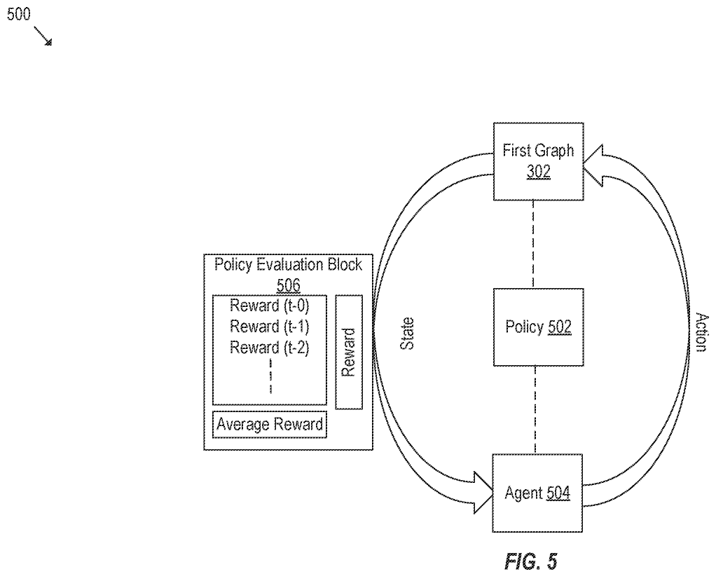

At 404, an operation of the application and re-training of the RL model 102A may be executed. In an embodiment, the processor 204 may be configured to apply the RL model 102A on the received first graph 302A. The RL model 102A may be an ML model that may learn based on a feedback-based learning method. Herein, an agent associated with the RL model 102A may perform an action and may learn based on an outcome of the performed action. A reward-based system may be employed for the training of the RL model 102A where a desired behavior may be rewarded, and the undesirable behavior may be penalized. In an example, the desired behavior may be shortening of a length of a tour. The first graph 302 may be applied to the RL model 102A. Details related to the RL model are further provided, for example, in FIG. 5.

Based on the application of the RL model 102A, the processor 204 may be configured to select a predefined number of a set of edges from the received first graph 302. Herein, the predefined number of the set of edges may be a number of edges that may be swapped with new edges in order to shorten a length of a tour associated with the received first graph 302. In an embodiment, a “K-opt” heuristic algorithm may be used to select the predefined number of the set of edges. Herein, the predefined number of the set of edges may be “K”. For example, the predefined number of the set of edges may be “4”. Thus, “4” edges of the first graph 302 may selected. It should be noted that the “K-opt” heuristic algorithm may be represented by a permutation of a set of disjoint segments along with a sequence of reversal moves on a subset of the set of disjoint segments. As an example, with reference to FIGS. 3 and 4, edges 306A, 306B, 306D, and 306G may be selected as the set of edges from the first graph 302.

Once the predefined number of the set of edges are selected, the processor 204 may be configured to delete the selected set of edges from the received first graph 302 to generate the second graph 408. The second graph 408 may be generated based on a disconnection of the set of segments associated with the selected set of edges from the received first graph 302A. The generated second graph 408 may correspond to a partial solution of the combinatorial optimization problem. As an example, with reference to FIGS. 3 and 4, edges 306A, 306B, 306D, and 306G may be selected as the set of edges. It may be observed from FIG. 3 that the edge 306A may connect the node 304A and the node 304C, the edge 306B may connect the node 304B and the node 304D, the edge 306D may connect the node 304D and the node 304E, and the edge 306G may connect the node 304A and the node 304G. With reference to FIG. 4, the segment associated with the edge 306A may be disconnected from the first graph 302 by disconnecting the node 304A from the node 304C. Similarly, the segment associated with the edge 306B may be disconnected by disconnecting the node 304B from the node 304D. The segment associated with the edge 306D may be disconnected by disconnecting the node 304D from the node 304E. The segment associated with the edge 306G may be disconnected by disconnecting the node 304A from the node 304G. Thus, the edges 306A, 306B, 306D, and 306G may be deleted from the received first graph 302 to generate the second graph 408.

Once the second graph 408 is generated, the processor 204 may be configured to determine, using the annealer-based solver 102B, a partial tour of the generated second graph 408 to generate the third graph 410. The third graph 410 may be generated based on a connection of the predefined number of a set of disjoint segments in the generated second graph 408. The generated third graph 410 may correspond to a new solution of the combinatorial optimization problem. In order to generate the generate the third graph 410, the set of disjoint segments may be connected. In an embodiment, the set of disjoint segments may be connected to the generated second graph 408 such that a length of the determined partial tour is minimum. For example, with reference to FIG. 4, the node 304C and the node 304D, the node 304D and the node 304G, the node 304B and the node 304A, and the node 304A and the node 304E of the second graph 408 are disconnected. Thus, the set of disjoint segments may be associated with a disconnection between the node 304C and the node 304D, a disconnection between the node 304D and the node 304G, a disconnection between the node 304B and the node 304A, and a disconnection between the node 304A and the node 304E of the second graph 408. In order to generate the third graph 410, in an example, the node 304C and the node 304D of the second graph 408 may be connected by the edge 410A, the node 304D and the node 304G of the second graph 408 may be connected by the edge 410B, the node 304B and the node 304A of the second graph 408 may be connected by the edge 410C, and the node 304A and the node 304E of the second graph 408 may be connected by the edge 410D. As the generated third graph 410 may be a tour, where each node is visited exactly once so as to return to the starting node at the end of the tour, the generated third graph 410 may correspond to a new solution of the combinatorial optimization problem (e.g., the TSP). For example, with reference to FIG. 3 and FIG. 4, a length of a tour associated with the generated third graph 410 may less than the length of the tour associated with the first graph 302. That is, the generated third graph 410 may be a more optimal solution for the combinatorial optimization problem than the received first graph 302.

Upon generation of the third graph 410, the processor 204 may be configured to re-train the RL model 102A based on the generated third graph 410, wherein the re-trained RL model 102A may be configured to determine an improved solution of the combinatorial optimization problem. The RL model 102A may learn from its own behavior. That is, the RL model 102A may learn based on the generated third graph 410. The reward-based system may be employed for the re-training of the RL model 102A. With reference to FIG. 3 and FIG. 4, a length of a tour associated with the generated third graph 410 may less than the length of the tour associated with the first graph 302. That is, the generated third graph 410 may be a more optimal solution for the combinatorial optimization problem than the received first graph 302. Therefore, the generated third graph 410 may be the desirable behavior and the RL model 102A may be rewarded. The re-trained RL model 102A may generate the improved solution based on the re-training. A length of a tour associated with the improved solution may be smaller than the length of the tour associated with the first graph 302 and equal to or smaller than the length of the tour associated with the generated third graph 410.

At 406, an operation of improved solution rendering may be executed. The processor 204 may be configured to render the determined improved solution of the combinatorial optimization problem on the display device 208A. In an example, the determined improved solution may be rendered on a user-device associated with a salesperson. The salesperson may then follow the path as indicated by the improved solution to cover each geographical location associated with the plurality of nodes of the improved solution exactly once in a shortest length (i.e., distance). The salesperson may return to the geographical location associated with the starting node at the end of the trip associated with the improved solution.

FIG. 5 is a diagram that illustrates an exemplary scenario for an RL model, in accordance with at least one embodiment described in the present disclosure. FIG. 5 is described in conjunction with elements from FIG. 1, FIG. 2, FIG. 3, and FIG. 4. With reference to FIG. 5, there is shown an exemplary scenario 500. The exemplary scenario 500 may include a first graph 302, a policy 502, an agent 504, and a policy evaluation block 506.

In an embodiment, the RL model 102A may correspond to a Markov decision process (MDP). With reference to FIG. 5, components of the MDP may include states “S”, actions “a”, transition models denoted as “P(s′|s, a)”, a reward function “R(s)”, and a policy “II(s)”. The MDP may begin with an initial state “so”. Each state “s” may be associated with an action “A(s)”. The transition model “P(s′|s, a)” may be a probability of going to a state “s” from the state “s”. MDP may indicate that the probability of going to state “s” from the state “s” may depend only on the state “s” and may be independent of previous states. The action that an agent may take in a given state may be dependent on the policy “II(s)”.

With reference to FIG. 5, in an example, the MDP may be “2-opt” optimization heuristic. Herein, the predefined number of the set of edges may be “2”. Thus, “2” edges of the first graph 302 may be deleted in each iteration of the optimization process. In an embodiment, the RL model 102A may include the agent 504 that may be configured to take an action corresponding to the deletion of the set of edges based on the policy 502 associated with the RL model 102A. The RL model 102A may further include a state machine that may be configured to transition the agent 504 from a first state to a second state, based on an evaluation of the policy 502, and each of the first state and the second state may correspond to a solution of the combinatorial optimization problem. In an example, a state “S̅” may be composed of a tuple according to an equation (1):

$$\overline{S} = ( S , {S}^{′} ) \qquad ( 1 )$$

where “S” may be current solution and “S′” may be a best/optimal solution as observed in a search. Further, the action may be modeled as a tuple according to an equation (2):

$$A = ( {a}_{1} , {a}_{2} ) \qquad ( 2 )$$

where “a₁” and “a₂” may be elements of numbers from “1” to “n” such that “a₂” greater than “a₁” may correspond to index position of a solution “S”, where “S” may be a set of intermediate solutions “s₁”, “s₂”, . . . , to “sₙ”.

Further, for a given action “A” where “A” may be equal to a tuple “(i,j)”, transitioning the agent 504 from the first state to the second state may define a deterministic change to a solution “Ŝ”. Herein, the solution “Ŝ” may be equal to “( . . . , sᵢ, . . . , sⱼ, . . . )”. The change in the solution “Ŝ” may result in a new solution and the state “S̅”. Herein, the new solution “S” may be equal to “( . . . , sᵢ₋₁, sⱼ, . . . , sᵢ, sⱼ₊₁ . . . )”. In an example, a node “i” and a node “j” in the solution “S” may be selected. Once the nodes are selected, an edge connecting a pair of nodes “i−1” and “i” and an edge connecting a pair of nodes “j” and “j+1” may be removed. Thereafter, a first new edge may be formed by connecting a pair of nodes “i−1” and “j” and a second a new edge may be formed by connecting a pair of nodes “i” and “j_+1”.

As discussed, a reward-based system may be employed for training the RL model 102A. Herein, a reward may be attributed to an action that may improve upon a current best-found solution. A reward associated to an action may be determined according to an equation (3):

$${R}_{t} = L ( {S}_{t}^{′} ) - L ( {S}_{t + 1}^{′} ) \qquad ( 3 )$$

where, “Rₜ” may be the reward, “L(Sₜ′)” may be a length of a solution “S′ₜ” obtained at an iteration “t”, and “L(Sₜ₊₁′)” may be a length of a solution “S′ₜ₊₁” obtained at an iteration “t+1”. Based on the reward generated according to the equation (3), the RL model 102A may be re-trained.

The RL model 102A may execute on an environment, for example, the first graph 302. The first graph 302 may correspond to the initial solution of the combinatorial optimization problem, on which the RL model 102A may be executed for “T” time steps. In each time step, multiple episodes of length “T1” less than or equal “T” may be defined. On completion of an episode a new episode may be started from the solution obtained in the preceding episode. The length of the episode may be increased after a number of epochs “e”.

The RL model 102A may thus, process and execute on the first graph 302 for “T” time steps in order to transition the agent 504 from the first state to the second state based on the evaluation of the policy 502. With reference to FIG. 5, the policy evaluation block 506 may include a set of rewards, for example, a reward “(t-0)”, a reward “(t-1)”, reward “(t-2)” and so on. The policy evaluation block 506 may further include an average reward based on averaging the set of rewards. Based on the policy evaluation block 506, the agent 504 may be transitioned from one state (such as, the first state) to another state (such as, the second state). Herein, the first state may be the solution at a step and the second state may be the solution at a succeeding step. Solution of each state may be the solution of the combinatorial optimization problem. An objective of the combinatorial optimization problem may be to minimize an expected return “Gₜ”. The expected return “Gₜ” may be determined according to an equation (4):

$${G}_{t} = {\sum }_{{t}^{′} = t}^{T - 1} {γ}^{{t}^{′} - t} {R}_{{t}^{′}} , where γ ∈ ( 0 , 1 ] \qquad ( 4 )$$

where, “γ” may be a discount factor, and “R_{t′}” may be the reward.

It should be noted that the scenario 500 of FIG. 5 is merely an example and such an example should not be construed as limiting the scope of disclosure.

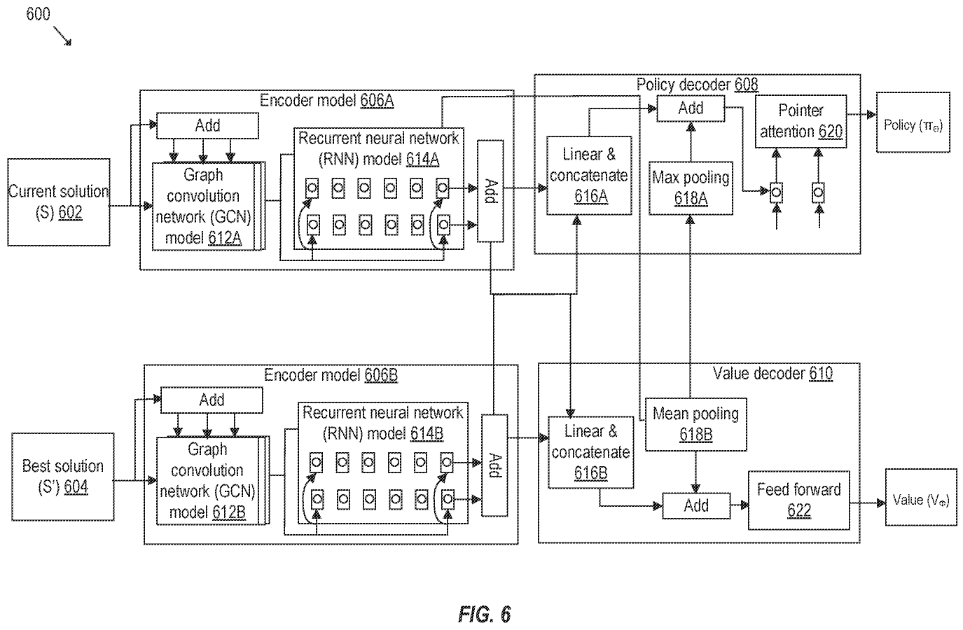

FIG. 6 is a diagram that illustrates an exemplary scenario for a policy gradient neural (PGN) model associated with an actor-critic architecture, in accordance with at least one embodiment described in the present disclosure. FIG. 6 is described in conjunction with elements from FIG. 1, FIG. 2, FIG. 3, FIG. 4, and FIG. 5. With reference to FIG. 6, there is shown an exemplary PGN model 600. The exemplary PGN model 600 may include a current solution (“S”) 602, a best solution (“S”) 604, an encoder model 606A, an encoder model 606B, a policy decoder 608, a value decoder 610, a graph convolution network (GCN) model 612A, a graph convolution network (GCN) model 612B, a recurrent neural network (RNN) model 614A, a recurrent neural network (RNN) model 614B, a linear and concatenate block 616A, a linear and concatenate block 616B, a max pooling block 618A, a mean pooling block 618B, a pointer attention block 620, and a feedforward block 622.

In an embodiment, the RL model 102A may correspond to a policy gradient neural PGN model 600 associated with the actor-critic architecture. In an embodiment, the PGN model 600 may include an encoder model (such as, the encoder model 606A and/or the encoder model 606B) that may be configured to obtain a node and tour representation from an input graph. The encoder model may include a graph convolution network (GCN) model (such as, the GCN model 612A and the GCN model 612B) and a recurrent neural network (RNN) model (such as, the RNN model 614A and the RNN model 614B). In an embodiment, the input graph may correspond to at least one of the new solution or the improved solution associated with the combinatorial optimization problem.

With reference to FIG. 6, the PGN model 600 may include the encoder model 606A and the encoder model 606B. The encoder model 606A may include GCN model 612A and RNN model 614A and the encoder model 606B may include GCN model 612B and RNN model 614B. The encoder model 606A may receive the input graph associated with the current solution (“S”) 602 and the encoder model 606A may receive the input graph associated with the best solution (“S”) 604. The encoder model 606A may determine an encoded representation for each node of the input graph associated with the current solution (“S”) 602. To determine the encoded representation of each node of an input graph associated with the current solution (“S”) 602, the encoder model 606A may employ the GCN model 612A and the RNN model 614A. The encoder model 606B may determine an encoded representation for each node of an input graph associated with the best solution (“S”) 604 based on an application of the GCN model 612B and the RNN model 614B.

In an embodiment, the GCN model (such as, the GCN model 612A and the GCN model 612B) may be configured to determine a topological structure associated with the input graph, and the RNN model (such as, the RNN model 614A and the RNN model 614B) may correspond to a Long Short-Term Memory (LSTM) model configured to determine a node ordering associated with the input graph. Herein, the topographical structure of the input graph may be obtained by representing the input graph in a planar form. Each node of the input graph may be represented in a form of a point and the edges associated with the input graph may be represented in a form of an arc that may connect a pair of nodes.

With reference to FIG. 6, the GCN model 612A may determine the topological structure associated with the input graph that may correspond to the current solution (“S”) 602. Similarly, the GCN model 612B may determine the topological structure associated with the input graph that may correspond to the best solution (“S”) 604. In an example, the GCN model 612A may output node representations also known as, nodal embeddings as “z₁”, “z₂” to “zₙ”. Thereafter, the RNN model 614A may determine a node ordering associated with the input graph corresponding to the current solution (“S”) 602. The RNN model 614 may be include two LSTM models that may be used as RNN functions. One RNN function may be associated with a forward LSTM model and another RNN function may be associated with a backward RNN function. The RNN functions may be computed using hidden vectors from a previous node in a tour and a current node embedding or a current nodal representation. A forward node representation associated with the forward LSTM model may be determined according to an equation (5):

$$( {h}_{i}^{\to } , {c}_{i}^{\to } ) = RNN ( {z}_{i}^{\to } , ( {h}_{i - 1}^{\to } , {c}_{i - 1}^{\to } ) ) , i ∈ ( 1 , … , n ) \qquad ( 5 )$$

where, “hᵢ^{→}” and “cᵢ^{→}” may be hidden vectors associated with the forward LSTM model. “zᵢ^{→}” may be the node representation obtained from the GCN model 612A. It may be observed from the equation (5) that the forward LSTM model may process the node representations obtained from the GCN model 612A from left to right.

A backward node representation associated with the backward LSTM model may be determined according to an equation (6):

$$( {h}_{i}^{←} , {c}_{i}^{←} ) = RNN ( {z}_{i}^{←} , ( {h}_{i + 1}^{←} , {c}_{i + 1}^{←} ) ) , i ∈ ( n , … , 1 ) , \qquad ( 6 )$$

where, “hᵢ^{←}” and “cᵢ^{←}” may be hidden vectors associated with the backward LSTM model. It may be observed from the equation (6) that the backward LSTM model may process the node representations obtained from the GCN model 612A from right to left. Once, the forward node representation and the backward node representation are determined, a final node representation may be obtained based on a combination of the forward node representation and the backward node representation. The final node representation may be determined according to an equation (7):

$${o}_{i} = tan h ( ( {W}_{f} {h}_{i}^{\to } + {b}_{f} ) + ( {W}_{b} {h}_{i}^{←} + {b}_{b} ) ) , {h}_{i} , {o}_{i} ∈ {ℝ}^{d} , {W}_{f} , {W}_{b} ∈ {ℝ}^{d \times d} and {b}_{f} , {b}_{b} ∈ {ℝ}^{d} \qquad ( 7 )$$

where “W_{f}” and “W_{b}” may be weights associated with the hidden vector “hᵢ^{→}” and the hidden vector “hᵢ^{←}” respectively; “b_{f}” and “b_{b}” may be biases associated with the hidden vector “hᵢ^{→}” and the hidden vector “hᵢ^{←}” respectively. Further, “oᵢ” may be a final node representation output.

A tour representation of the current solution (“S”) 602 may be determined according to an equation (8):

$${h}_{n} = {h}_{n}^{\to } + {h}_{n}^{←} \qquad ( 8 )$$

where “hₙ” may be the tour representation, “hⁿ′” may be the hidden vector associated with the forward LSTM model, and “hₙ^{←}” may be the hidden vector associated with the backward LSTM model. Similarly, the final node representation and the tour representation associated with the best solution (“S”) 604 may be obtained.

In an embodiment, the PGN model 600 may include a decoder model including the policy decoder 608 and the value decoder 610. The policy decoder 608 may be configured to sample actions of an agent associated with the RL model 102A and learn a stochastic policy applicable on the agent (for example, the agent 504 of FIG. 5). The PGN model 600 may further include the value decoder 610 that may be configured to estimate state values associated with the RL values.

With reference to FIG. 6, the policy decoder 608 may learn parameters associated a stochastic policy. The stochastic policy may be learnt according to an equation (9):

$${π}_{θ} ( A \vert \overline{S} ) = {\prod }_{i = 1}^{k} {p}_{θ} ( {a}_{i} \vert {a}_{< i} , \overline{S} ) \qquad ( 9 )$$

where “π_{θ}(A|S̅)” may be the stochastic policy, “p_{θ}(aᵢ|a_{>i}, S̅)” may be a SoftMax function, “aᵢ” may correspond to a node position in a tour, and “k” may be a constant. In an example, “k” may be equal to 2 for the 2-opt MDP.

At each output step “i”, tour embedding vectors may be mapped to a following query vector according to an equation (10)

$${q}_{i} = tan h ( ( {W}_{q} {q}_{i - 1} + {b}_{q} ) + ( {W}_{o} {o}_{i - 1} + {b}_{o} ) ) , {W}_{q} , {W}_{o} ∈ {ℝ}^{d \times d} , {b}_{q} , {b}_{o} ∈ {ℝ}^{d} \qquad ( 10 )$$

where “W_{q}”, “Wₒ”, “b_{q}”, and “bₒ” may be learnable parameters. “qᵢ” may be a query vector associated with the output step “i”, “qᵢ₋₁” may be a query vector associated with an output step “i−1”, and “qₒ” may be an initial query vector

In order to determine the initial query vector “qₒ”, a combined tour representation may be determined based on the tour representation from the current solution (“S”) 602 and the tour representation from the best solution (“S”) 604. The combined tour representation may be determined according to an equation (11):

$${h}_{\overline{s}} = ( {W}_{s} {h}_{n} + {b}_{s} ‖ {W}_{{s}^{′}} {h}_{n}^{′} + {b}_{{s}^{′}} ) , {W}_{{s}^{′}} {W}_{{s}^{′}} ∈ {ℝ}^{\frac{d}{2} \times d} , {b}_{s} , {b}_{{s}^{′}} ∈ {ℝ}^{\frac{d}{2}} \qquad ( 11 )$$

where “h_{s̅}” may be the combined tour representation, “Wₛ”, “Wₛ′”, “bₛ”, and “bₛ′” may be learning parameters, and “∥” may represent concatenation operation performed by the linear and concatenate block 616A. Thereafter, a max pooling graph representation “z_{g}” may be obtained from the max pooling 618A. The initial query vector “q.” may be an addition of combined tour representation “h_{s̅}” and the max pooling graph representation “z_{g}”. In this way, the query vector “qᵢ” may be obtained. Once the query vector “qᵢ” is obtained, the pointer attention 620 may then define a pointing distribution over an action space based on the query vector “qᵢ”. A policy “πₑ” may be finally obtained from the pointer attention 620.

With reference to FIG. 6, the PGN model 600 may further include the value decoder 610 that may be configured to the estimate state values associated with the RL values. The value decoder 610 may work in a similar manner as the policy decoder 608. For a given set of nodal embeddings “Z”, the value decoder 610 may estimate the value “V_{Φ}” based on an application of the mean pooling 618B. The value “V_{Φ}” may be based on an output “zᵢ” for each node in the tour, the tour representation “hₙ” of the current solution (“S”) 602, and the tour representation “hₙ′” of the best solution (“S”) 604.

It should be noted that the PGN model 600 of FIG. 6 is merely an example, and such an example should not be construed as limiting the scope of the disclosure.

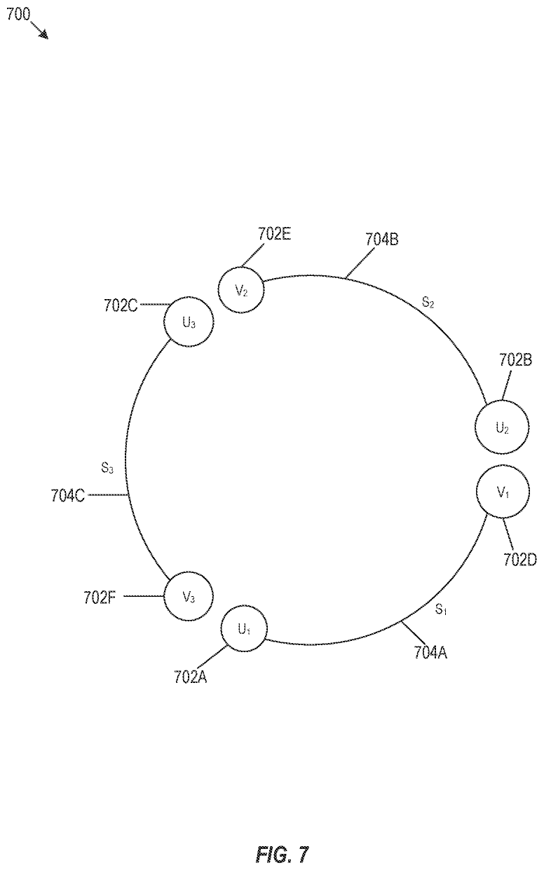

FIG. 7 is a diagram that illustrates an exemplary scenario for a set of disjoint segments, in accordance with at least one embodiment described in the present disclosure. FIG. 7 is described in conjunction with elements from FIG. 1, FIG. 2, FIG. 3, FIG. 4, FIG. 5, and FIG. 6. With reference to FIG. 7, there is shown an exemplary scenario 700. The exemplary scenario 700 may include a node “U₁” 702A, a node “U₂” 702B, a node “U₃” 702C, a node “V₁” 702D, a node “V₂” 702E, and a node “V₃” 702F. The exemplary scenario 700 may further include a segment “S₁” 704A, a segment “S₂” 704B, and a segment “S₃” 704C.

In an embodiment, the processor 204 may be configured to determine a permutation of the set of disjoint segments to be connected. The processor 204 may be further configured to select one or more segments of the set of disjoint segments. The processor 204 may be further configured to reverse an order associated with each of the selected one or more segments. The processor 204 may be further configured to connect the selected one or more segments based on the determined permutations and the reversed order, wherein the partial tour of the generated second graph may be determined further based on the connection of the selected one or more segments. In an example, the set of disjoint segments may include “k” number of segments such as, “s₁”, “s₂”, to . . . “sₖ”, that may be obtained based on a deletion “k” number of edges from a tour. Once the “k” number of segments are obtained, the permutation of the k″ number of segments may be obtained. Thereafter, one or more segments may be selected. For example, a segment “sᵢ” may be selected. In the selected segment “sᵢ” the nodes may be visited in a sequence where firstly, a second node “2” may be visited. Next, a third node “3” may be vised. Thereafter, the fourth node “4” may be visited. Finally, the fifth node “5” may be visited. The sequence of visiting the nodes may be reversed in the selected segment. That is, firstly, the fifth node “5” may be visited. Next, a third node “4” may be vised. Thereafter, the fourth node “3” may be visited. Finally, the fifth node “2” may be visited. The selected segment “sᵢ” may then be connected based on the determined permutations and the reversed order.

In an embodiment, the processor 204 may be configured to determine an action matrix associated with the RL model 102A based on at least one of the selected set of edges to be deleted, a permutation of the set of disjoint segments to be connected, or one or more segments of the set of disjoint segments to be reversed. The processor 204 may be configured to evaluate a policy associated with the RL model 102A based on the determined action matrix, wherein the partial solution may be determined further based on the evaluation of the policy.

In order to determine an action matrix “A” for “n” number of edges associated with a graph (such as, the received first graph 302 of FIG. 3), a deletion matrix “D” of “n” number of rows and “1” number of columns may be obtained. The deletion matrix “D” may include elements from a vector “{0,1}ⁿ”. That is, the deletion matrix “D” may be a vector indicating the edges of the current tour that may be deleted. Herein, a “1” in a row of the deletion matrix “D” may indicate deletion of an edge associated with the corresponding row. Thereafter, a permutation matrix “P” of “n” number of rows and “1” number of columns may be obtained by permutating the “n” number of edges. Further, a reversal matrix “R” of “n” number of rows and “1” number of columns may be obtained. The reversal matrix “R” may include elements from a vector “{0,1}ⁿ”. The reversal matrix “R” may be a vector indicating the segments that should be reversed. Herein, a “1” in a row of the reversal matrix “R” may indicate reversal of an order of nodes in an edge associated with the corresponding row. It should be noted that the action matrix “A” may be represented as “[D P R]”.

An example of the action matrix “A” is represented in an equation (12):

$$A = ( \begin{matrix}0 & 1 & 0 \\ 1 & 2 & 1 \\ 0 & 5 & 1 \\ 1 & 3 & 0 \\ 0 & 4 & 1\end{matrix} ) . \qquad ( 12 )$$

A first column of the action matrix “A” may be the deletion matrix “D”. A second column of the action matrix “A” may be the permutation matrix “P” and a third column of the action matrix “A” may be the reversal matrix “R”. From the first column of the action matrix “A”, as provided in the equation (12), it may be observed that a second and a fourth edge of a graph associated with the current solution may be deleted. From the third column of the action matrix “A”, as provided in the equation (12), it may be observed that order of nodes in edges associated with a second row, a third row, and a fifth row may be reversed. Once, the action matrix “A” is determined, the policy associated with the RL model 102A may be evaluated to determine the partial solution.

With reference to FIG. 7, the set of disjoint segments may include the segment “S₁” 704A, the segment “S₂” 704B, and the segment “S₃” 704C. Thus, the segment “S₁” 704A, the segment “S₂” 704B, and the segment “S₃” 704C may be permutated. Thereafter, the one or more segments of the set of disjoint segments may be selected. For example, the segment “S₂” 704B may be selected and the order of the nodes on the segment “S₂” 704B may be then reversed. Thereafter, the segment “S₂” 704B may be connected based on the determined permutations and the reversed order.

It should be noted that the scenario 700 of FIG. 7 is merely an example and such an example should not be construed as limiting the scope of the disclosure.

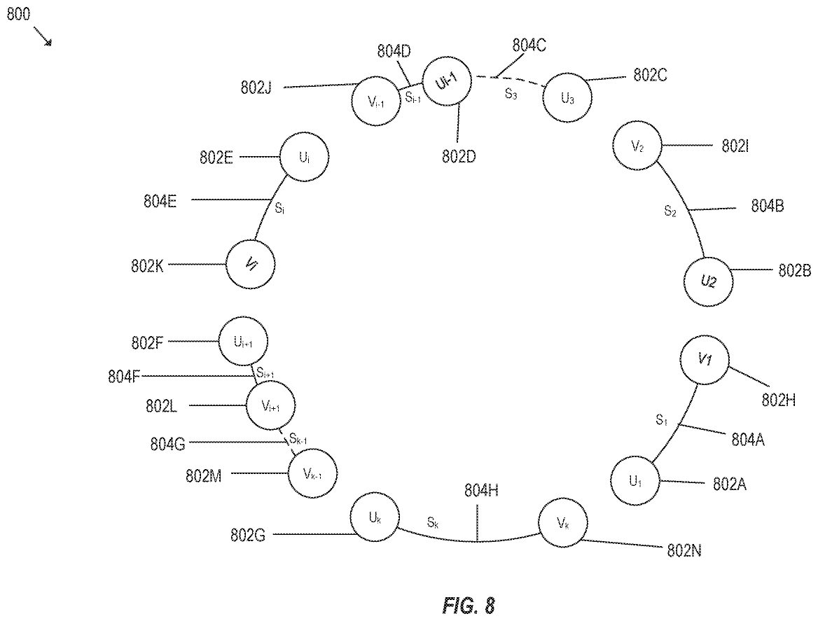

FIG. 8 is a diagram that illustrates an exemplary scenario for reconnecting the set of disjoint segments, in accordance with at least one embodiment described in the present disclosure. FIG. 8 is described in conjunction with elements from FIG. 1, FIG. 2, FIG. 3, FIG. 4, FIG. 5, FIG. 6, and FIG. 7. With reference to FIG. 8, there is shown an exemplary scenario 800. The exemplary scenario 800 may include a node “U₁” 802A, a node “U₂” 802B, a node “U₃” 802C, a node “Uᵢ₋₁” 802D, a node “Uᵢ” 802E, a node “Uᵢ₊₁” 802F, a node “Uₖ” 802G, a node “V₁” 802H, a node “V₂” 8021, a node “Vᵢ₋₁” 802J, a node “Vᵢ” 802K, a node “Vᵢ₊₁” 802L, a node “Vₖ₋₁” 802M, and a node “Vₖ” 802N. The exemplary scenario 700 may further include a set of disjoint segments such as, a segment “S₁” 804A, a segment “S₂” 804B, a segment “S₃” 804C, a segment “S₄” 804D, a segment “Sᵢ” 804E, a segment “Sᵢ₊₁” 804F, a segment “Sₖ₋₁” 80G, and a segment “Sₖ” 804H.

The K number of segments shown in FIG. 8 is presented merely as an example. The K number of segments may include only one segment or more than k segments, without deviation from the scope of the disclosure. For the sake of brevity, only K number of segments have been shown in FIG. 8. However, in some embodiments, there may be more than K number of segments, without limiting the scope of the disclosure.

With reference to FIG. 8, each segment of the set of disjoint segments may be associated with a pair of end nodes. For example, the segment “Sᵢ” 804E may include the pair of end nodes as the node “Uᵢ” 802E and the node “Vᵢ” 802K. Thus, for “K” number of segments, a number of end nodes that may be associated with the “K” number of segments may be twice the “K” number of segments. That is, the number of end nodes for “K” number of segments may be 2K end nodes. The “K” number of segments may be reconnected to form a tour which may be minimized such that the length of the tour may be minimum by solving the combinatorial optimization problem. If a pair of nodes “(i,j)” may be the endpoints of a same segment, then the node “i” may be either visited exactly one step before visiting the node “j” or exactly one step after visiting the node “j”. This may be implemented by setting a weight “w_{i,j}” of the segment associated with the pair of nodes “(i,j)” as a large negative number. Based on the aforesaid constraints, the combinatorial optimization problem may be defined as the quadratic unconstrained binary optimization (QUBO) according to an equation (11):

$$Q = {min}_{x} {\sum }_{( u , v ) ∈ E} ( {w}_{u , v} {\sum }_{j = 1}^{2 k} {x}_{u , j} {x}_{v , j + 1} ) + {\sum }_{( u , v ) ∈ E} ( {w}_{u , v} {x}_{u , 2 k} {x}_{v , 1} ) \qquad ( 13 )$$

$$such that ,$$

$${\sum }_{i}^{2 k} {x}_{i , j} = 1 , for j = 1 , 2 , … , 2 k$$

$${\sum }_{j}^{2 k} {x}_{i , j} = 1 , for i = 1 , 2 , … , 2 k$$

$$x ∈ {\{ 0 , 1 \}}^{2 k}$$

where “Q” may be the combinatorial optimization problem. “x_{i,p}” may be a binary variable that may take a value of “1” in case the node “i” is visited. Further, the value of the binary variable “x_{i,p}” may be “0” in case the node “i” is unvisited. “W_{u,v}” may be a weight associated with a segment having the pair of end nodes as “(u,v)”. With reference to FIG. 8, by solving the combinatorial optimization problem of the equation (13), a new solution of a graph associated with the set of disjoint segments may be obtained.

It should be noted that the scenario 800 of FIG. 8 is merely an example and such an example should not be construed as limiting the scope of the disclosure.

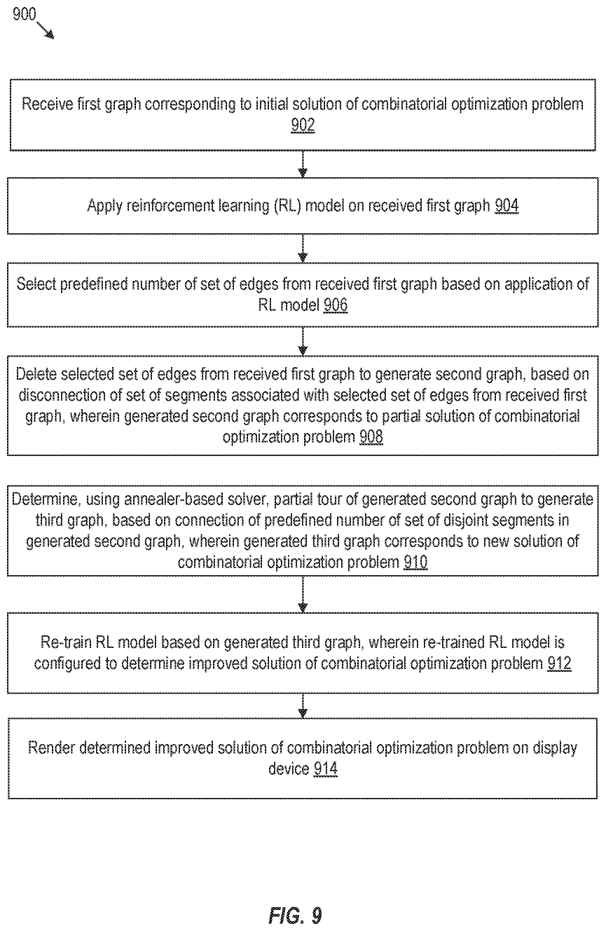

FIG. 9 is a diagram that illustrates a flowchart of an example method for the local-search based solution of the combinatorial optimization problem using the annealer-based solvers, in accordance with an embodiment of the disclosure. FIG. 9 is described in conjunction with elements from FIG. 1, FIG. 2, FIG. 3, FIG. 4, FIG. 5, FIG. 6, FIG. 7, and FIG. 8. With reference to FIG. 9, there is shown a flowchart 900. The method illustrated in the flowchart 900 may start at 902 and may be performed by any suitable system, apparatus, or device, such as, by the example electronic device 102 of FIG. 1, or the processor 204 of FIG. 2. Although illustrated with discrete blocks, the steps and operations associated with one or more of the blocks of the flowchart 900 may be divided into additional blocks, combined into fewer blocks, or eliminated, depending on the particular implementation.

At block 902, the first graph (for example, the first graph 302 of FIG. 3) corresponding to the initial solution of the combinatorial optimization problem may be received. In an embodiment, the processor 204 may be configured to receive the first graph (for example, the first graph 302 of FIG. 3) corresponding to the initial solution of the combinatorial optimization problem. Details related to the first graph are further provided for example, in FIG. 3.

At block 904, the RL model 102A may be applied on the received first graph (for example, the first graph 302 of FIG. 3). In an embodiment, the processor 204 may be configured to apply the RL model 102A on the received first graph (for example, the first graph 302 of FIG. 3). Details related to the application of the RL model 102A are further provided for example, in FIG. 4.

At block 906, the predefined number of the set of edges may be selected from the received first graph (for example, the first graph 302 of FIG. 3) based on the application of the RL model 102A. In an embodiment, the processor 204 may be configured to select the predefined number of the set of edges from the received first graph (for example, the first graph 302 of FIG. 3) based on the application of the RL model 102A. Details related to the selection of the predefined number of the set of edges are further provided for example, in FIG. 4.

At block 908, the selected set of edges may be deleted from the received first graph (for example, the first graph 302 of FIG. 3) to generate the second graph (for example, the second graph 408 of FIG. 4). The selected set of edges may be deleted based on the disconnection of the set of segments associated with the selected set of edges from the received first graph (for example, the first graph 302 of FIG. 3). Herein, the generated second graph (for example, the second graph 408 of FIG. 4) may correspond to the partial solution of the combinatorial optimization problem. In an embodiment, the processor 204 may be configured to delete the selected set of edges from the received first graph (for example, the first graph 302 of FIG. 3) to generate the second graph (for example, the second graph 408 of FIG. 4), based on the disconnection of the set of segments associated with the selected set of edges from the received first graph (for example, the first graph 302 of FIG. 3), wherein the generated second graph (for example, the second graph 408 of FIG. 4) may correspond to the partial solution of the combinatorial optimization problem. Details related to the deletion of the selected set of edges are further provided for example, in FIG. 4.

At block 910, the partial tour of the generated second graph (for example, the second graph 408 of FIG. 4) may be determined, using the annealer-based solver 102B to generate the third graph, based on the connection of the predefined number of the set of disjoint segments in the generated second graph (for example, the second graph 408 of FIG. 4). Herein, the generated third graph (for example, the third graph 410 of FIG. 4) may correspond to the new solution of the combinatorial optimization problem. In an embodiment, the processor 204 may be configured to determine, using the annealer-based solver 102B, the partial tour of the generated second graph (for example, the second graph 408 of FIG. 4) to generate the third graph, based on the connection of the predefined number of the set of disjoint segments in the generated second graph (for example, the second graph 408 of FIG. 4). Herein, the generated third graph (for example, the third graph 410 of FIG. 4) may correspond to the new solution of the combinatorial optimization problem. Details related to the determination of the partial tour are further provided for example, in FIG. 4.

At block 912, the RL model 102A may be re-trained based on the generated third graph (for example, the third graph 410 of FIG. 4), wherein the re-trained RL model 102A may be configured to determine the improved solution of the combinatorial optimization problem. In an embodiment, the processor 204 may be configured to re-train the RL model 102A based on the generated third graph (for example, the third graph 410 of FIG. 4). Herein, the re-trained RL model 102A may be configured to determine the improved solution of the combinatorial optimization problem. Details related to the re-training of the RL model 102A are further provided for example, in FIG. 4.

At block 914, the determined improved solution of the combinatorial optimization problem may be rendered on the display device 208A. In an embodiment, the processor 204 may be configured to render the determined improved solution of the combinatorial optimization problem on the display device 208A. Details related to the rendering of the determined improved solution are further provided for example, in FIG. 4. Control may pass to end.

Although the flowchart 900 is illustrated as discrete operations, such as 902, 904, 906, 908, 910, 912, and 914. However, in certain embodiments, such discrete operations may be further divided into additional operations, combined into fewer operations, or eliminated, depending on the particular implementation without detracting from the essence of the disclosed embodiments.

Various embodiments of the disclosure may provide one or more non-transitory computer-readable storage media configured to store instructions that, in response to being executed, cause a system (such as, the example electronic device 102) to perform operations. The operations may include receiving a first graph (for example, the first graph 302 of FIG. 3) corresponding to an initial solution of a combinatorial optimization problem. The operations may include applying a RL model (for example, the RL model 102A of FIG. 1) on the received first graph (for example, the first graph 302 of FIG. 3). The operations may further include selecting a predefined number of a set of edges from the received first graph (for example, the first graph 302 of FIG. 3) based on the application of the RL model (for example, the RL model 102A of FIG. 1). The operations may further include deleting the selected set of edges from the received first graph (for example, the first graph 302 of FIG. 3) to generate a second graph (for example, the second graph 408 of FIG. 4), based on a disconnection of a set of segments associated with the selected set of edges from the received first graph (for example, the first graph 302 of FIG. 3), wherein the generated second graph (for example, the second graph 408 of FIG. 4) may correspond to the partial solution of the combinatorial optimization problem. The operations may further include determining, using an annealer-based solver (for example, annealer-based solver 102B of FIG. 1), a partial tour of the generated second graph (for example, the second graph 408 of FIG. 4) to generate a third graph, based on a connection of the predefined number of the set of disjoint segments in the generated second graph (for example, the second graph 408 of FIG. 4), wherein the generated third graph (for example, the third graph 410 of FIG. 4) may correspond to a new solution of the combinatorial optimization problem. The operations may further include re-training the RL model (for example, RL model 102A of FIG. 1) based on the generated third graph (for example, the third graph 410 of FIG. 4), wherein the re-trained RL model (for example, RL model 102A of FIG. 1) may be configured to determine an improved solution of the combinatorial optimization problem. The operations may further include rendering the determined improved solution of the combinatorial optimization problem on the display device 208A.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of“A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by a processor, comprising:
receiving a first graph corresponding to an initial solution of a combinatorial optimization problem;
applying a reinforcement learning (RL) model on the received first graph;
selecting a predefined number of a set of edges from the received first graph based on the application of the RL model;
deleting the selected set of edges from the received first graph to generate a second graph, based on a disconnection of a set of segments associated with the selected set of edges from the received first graph, wherein
the generated second graph corresponds to a partial solution of the combinatorial optimization problem;
determining, using an annealer-based solver, a partial tour of the generated second graph to generate a third graph, based on a connection of the predefined number of a set of disjoint segments in the generated second graph, wherein
the generated third graph corresponds to a new solution of the combinatorial optimization problem;
re-training the RL model based on the generated third graph, wherein
the re-trained RL model is configured to determine an improved solution of the combinatorial optimization problem; and
rendering the determined improved solution of the combinatorial optimization problem on a display device.

2. The method according to claim 1, wherein the combinatorial optimization problem corresponds to at least one of an assignment problem, a closure problem, a constraint satisfaction problem, a cutting stock problem, a dominating set problem, an integer programming problem, a knapsack problem, a minimum relevant variables in linear system problem, a minimum spanning tree problem, a nurse scheduling problem, a set cover problem, a job shop scheduling problem, a traveling salesman problem, a vehicle rescheduling problem, a vehicle routing problem, a weapon target assignment problem, a bin packing problem, or a talent scheduling problem.

3. The method according to claim 1, wherein the RL model corresponds to a Markov Decision Process (MDP).

4. The method according to claim 1, wherein
the RL model includes an agent configured to take an action corresponding to the deletion of the set of edges based on a policy associated with the RL model,
the RL model further includes a state machine that is configured to transition the agent from a first state to a second state, based on an evaluation of the policy, and
each of the first state and the second state corresponds to a solution of the combinatorial optimization problem.

5. The method according to claim 1, wherein the RL model corresponds to a policy gradient neural (PGN) model associated with an actor-critic architecture.

6. The method according to claim 5, wherein
the PGN model includes an encoder model configured to obtain a node and tour representation from an input graph, and
the encoder model includes a graph convolution network (GCN) model and a recurrent neural network (RNN) model.

7. The method according to claim 6, wherein
the GCN model is configured to determine a topological structure associated with the input graph, and
the RNN model corresponds to a Long Short-Term Memory (LSTM) model configured to determine a node ordering associated with the input graph.

8. The method according to claim 6, wherein the input graph corresponds to at least one of the new solution or the improved solution associated with the combinatorial optimization problem.

9. The method according to claim 5, wherein
the PGN model includes a decoder model including a policy decoder and a value decoder,
the policy decoder is configured to sample actions of an agent associated with the RL model and learn a stochastic policy applicable on the agent, and
the value decoder is configured to estimate state values associated with the RL values.

10. The method according to claim 1, further comprising:
determining a permutation of the set of disjoint segments to be connected;
selecting one or more segments of the set of disjoint segments;
reversing an order associated with each of the selected one or more segments; and
connecting the selected one or more segments based on the determined permutations and the reversed order, wherein
the partial tour of the generated second graph is determined further based on the connection of the selected one or more segments.

11. The method according to claim 1, further comprising:
determining an action matrix associated with the RL model based on at least one of the selected set of edges to be deleted, a permutation of the set of disjoint segments to be connected, or one or more segments of the set of disjoint segments to be reversed; and
evaluating a policy associated with the RL model based on the determined action matrix, wherein
the partial solution is determined further based on the evaluation of the policy.

12. The method according to claim 1, wherein the set of disjoint segments is connected to the generated second graph such that a length of the determined partial tour is minimum.

13. One or more non-transitory computer-readable storage media configured to store instructions that, in response to being executed, cause an electronic device to perform operations, the operations comprising:
receiving a first graph corresponding to an initial solution of a combinatorial optimization problem;
applying a reinforcement learning (RL) model on the received first graph;
selecting a predefined number of a set of edges from the received first graph based on the application of the RL model;
deleting the selected set of edges from the received first graph to generate a second graph, based on a disconnection of a set of segments associated with the selected set of edges from the received first graph, wherein
the generated second graph corresponds to a partial solution of the combinatorial optimization problem;
determining, using an annealer-based solver, a partial tour of the generated second graph to generate a third graph, based on a connection of the predefined number of a set of disjoint segments in the generated second graph, wherein
the generated third graph corresponds to a new solution of the combinatorial optimization problem;
re-training the RL model based on the generated third graph, wherein
the re-trained RL model is configured to determine an improved solution of the combinatorial optimization problem; and
rendering the determined improved solution of the combinatorial optimization problem on a display device.

14. The one or more non-transitory computer-readable storage media according to claim 13, wherein the combinatorial optimization problem corresponds to at least one of an assignment problem, a closure problem, a constraint satisfaction problem, a cutting stock problem, a dominating set problem, an integer programming problem, a knapsack problem, a minimum relevant variables in linear system problem, a minimum spanning tree problem, a nurse scheduling problem, a set cover problem, a job shop scheduling problem, a traveling salesman problem, a vehicle rescheduling problem, a vehicle routing problem, a weapon target assignment problem, a bin packing problem, or a talent scheduling problem.

15. The one or more non-transitory computer-readable storage media according to claim 13, wherein the RL model corresponds to a Markov Decision Process (MDP).

16. The one or more non-transitory computer-readable storage media according to claim 13, wherein the RL model corresponds to a policy gradient neural (PGN) model associated with an actor-critic architecture.

17. The one or more non-transitory computer-readable storage media according to claim 13, wherein the operations further comprise:
determining a permutation of the set of disjoint segments to be connected;
selecting one or more segments of the set of disjoint segments;
reversing an order associated with each of the selected one or more segments; and
connecting the selected one or more segments based on the determined permutations and the reversed order, wherein
the partial tour of the generated second graph is determined further based on the connection of the selected one or more segments.

18. The one or more non-transitory computer-readable storage media according to claim 13, wherein the operations further comprise:
determining an action matrix associated with the RL model based on at least one of the selected set of edges to be deleted, a permutation of the set of disjoint segments to be connected, or one or more segments of the set of disjoint segments to be reversed; and
evaluating a policy associated with the RL model based on the determined action matrix, wherein
the partial solution is determined further based on the evaluation of the policy.

19. The one or more non-transitory computer-readable storage media according to claim 13, wherein the set of disjoint segments is connected to the generated second graph such that a length of the determined partial tour is minimum.

20. An electronic device, comprising:
a memory configured to store instructions; and
a processor, coupled to the memory, configured to execute the instructions to perform a process comprising:
receiving a first graph corresponding to an initial solution of a combinatorial optimization problem;
applying a reinforcement learning (RL) model on the received first graph;
selecting a predefined number of a set of edges from the received first graph based on the application of the RL model;
deleting the selected set of edges from the received first graph to generate a second graph, based on a disconnection of a set of segments associated with the selected set of edges from the received first graph, wherein
the generated second graph corresponds to a partial solution of the combinatorial optimization problem;
determining, using an annealer-based solver, a partial tour of the generated second graph to generate a third graph, based on a connection of the predefined number of a set of disjoint segments in the generated second graph, wherein
the generated third graph corresponds to a new solution of the combinatorial optimization problem;
re-training the RL model based on the generated third graph, wherein
the re-trained RL model is configured to determine an improved solution of the combinatorial optimization problem; and
rendering the determined improved solution of the combinatorial optimization problem on a display device.
